(19) United States
(12) Patent Application Publication
(10) Pub. No.: US 2003/0103632 A1
(43) Pub. Date: Jun. 5, 2003

(54) Adaptive sound masking system and method

(76) Inventors: Rafik Goubran, Ottawa (CA); Radamis Botros, Ottawa (CA)

Correspondence Address: Achmed N. Sadik, P.O. Box 908, Station B, Ottawa, ON, K1P 5P9, CA

(21) Appl. No.: 09/998,191

(22) Filed: Dec. 3, 2001

(51) Int. Cl. H04R 3/02; H04B 15/00

(52) U.S. Cl. 381/73.1; 381/94.1

(57) ABSTRACT

An adaptive sound masking system and method portions undesired sound into time-blocks and estimates frequency spectrum and power level, and continuously generates white noise with a matching spectrum and power level to mask the undesired sound.

### BACKGROUND OF THE INVENTION

1. Field of the Invention

The present invention is directed to undesired-sound masking systems in general, and in particular to an adaptive noise generating system to mask interfering sounds emanating or leaking from other sources.

2. Prior Art of the Invention

Generation of masking background noise in order to reduce the intelligibility of sounds leaked from adjacent areas or sources is generally known in the art.

The known masking systems generate constant background noise, the spectrum of which is shaped in such a way as to mask speech at least to some extent.

There are some problems associated with such approach, such as:

the level of the noise is constant and does not adapt to the room conditions;

the spectrum of the noise is constant and does not adapt to the room conditions; and

the masking noise is annoying to the listeners; it does not stop when the room is silent.

### SUMMARY OF THE INVENTION

The present invention endeavors to mitigate some of the prior art problems by providing a system and method in which:

(a) The masking noise adapts, dynamically, to the characteristics of the leaked, interfering, sound by having a similar frequency range and an appropriate amplitude range;

(b) The level of the masking sound is minimized while achieving the desired reduction in intelligibility and scrambling.

More particularly, the method of the present invention comprises the following steps:

(i) acquire the signal from the room;

(ii) form a block (256 to 1024 msec);

(iii) estimate the power level of the signal in a given block. (e.g. by adding the squares of the samples and dividing by the total number of samples in the block, or by using a simple IIR filter);

(iv) estimate its Frequency Spectrum (e.g. by splitting the signal into frequency bins and calculating the power of each bin, or by doing a Fast Fourier Transform); and

(v) generate white noise and control its energy and spectrum to match the conditions of the signal in the room on a continuous basis

The system to carry out the above method is preferably a stand-alone circuit board based on an energy efficient DSP processor and memory, and an analog interface chip (AIC). A suitable DSP is sold by Texas instruments as Part No. TMS320-C542, and a suitable AIC by the same company is Part No. TLS2040. Of course, other similarly suitable devices are available in the marketplace.

### BRIEF DESCRIPTION OF THE DRAWINGS

The preferred exemplary embodiments of the present invention will now be described in detail in conjunction with the annexed drawings, in which:

FIG. 1 is a block diagram of the adaptive system for sound making according to the present invention;

FIG. 2 is a block diagram of the noise-shaping filter shown in FIG. 1; and

FIG. 3 depicts the preferred system requirements for the adaptive system shown in FIG. 1.

### DETAILED DESCRIPTION OF THE DRAWINGS

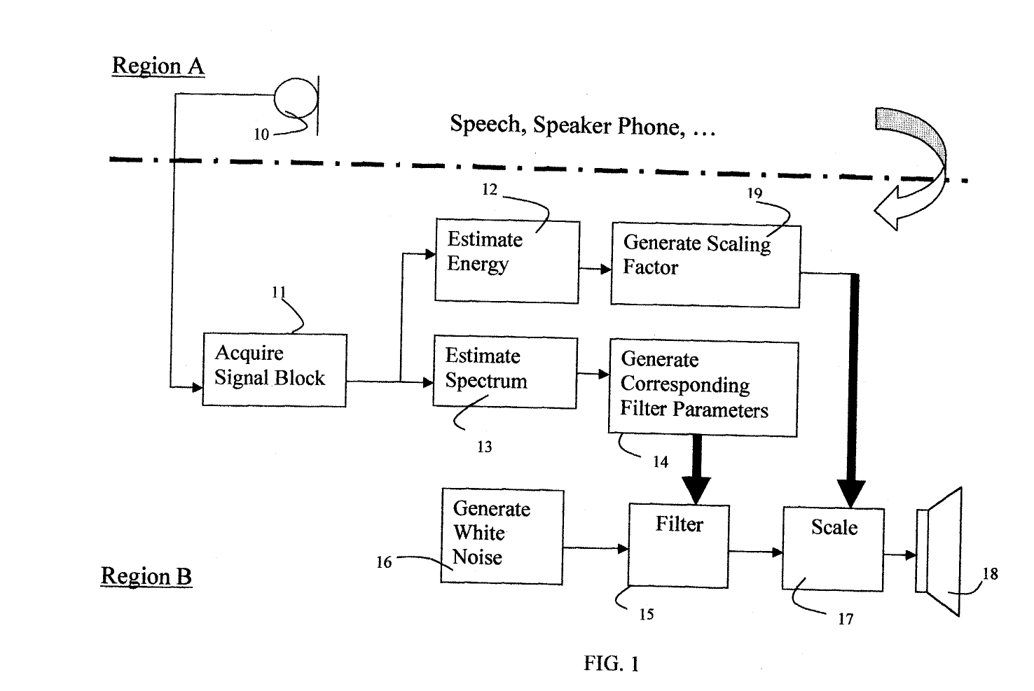

Referring to FIG. 1 of the drawings, the system of the present invention comprises a microphone 10 located at the border of, or in, a region A from which an interfering sound is leaking into a region B (the masking region). The output signal from the microphone 10 is applied to and partitioned into output signal blocks of, say, between 256 and 1024 m seconds in acquisition circuit 11, the output of which is applied to energy and spectrum estimators 12 and 13, respectively. The energy estimated 13 output is applied to a spectrum shaping generator 14 which generates shaping filter 15 parameters. The filter 15 filters the output of a white noise generator 16 and applies the spectrally conditioned white noise to a scaling amplifier 17, which drive a masking loudspeaker 18 located in the region of interest B. The scaling amplifiers 17 gain is controlled by a scaling factor generator 19, which is driven by the energy estimator 12, such that the higher the estimated interfering sound energy from the region A, the larger is the gain of the scaling amplifier 17.

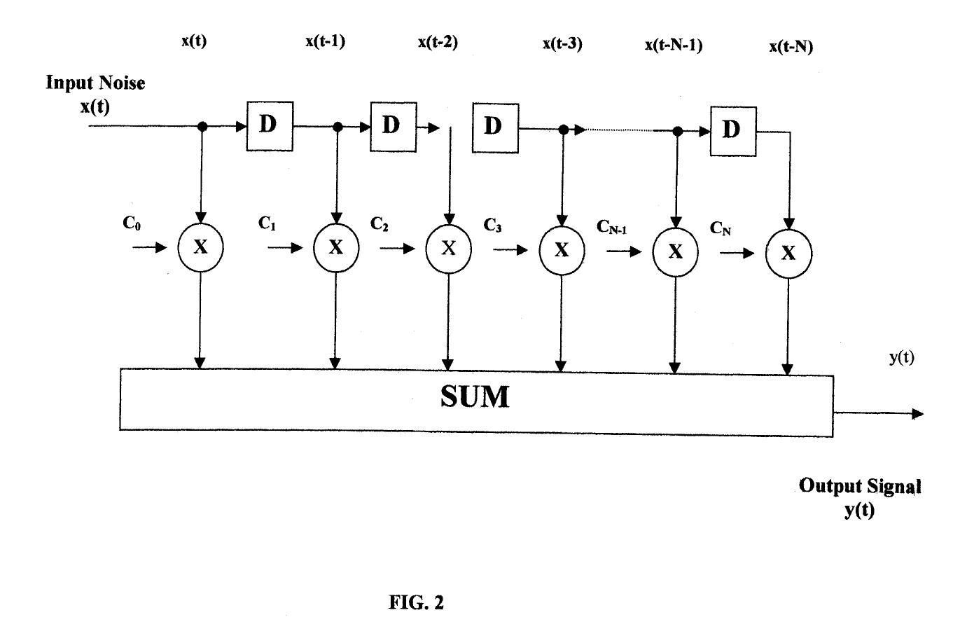

The spectrum shaping filter 15 is shown in FIG. 2. The filter 15 receives the input white noise x(t), processes it in N stages separated by N equal delays D, the outputs of which are multiplied by factors Cₒ to C_{N} then summed in sum—SUM to yield the spectrum shaped output symbol y(t), which is then applied to the scaling amplifier 17. Thus, the output y(t) is a modified version of x(t) as follows

$$y ( t ) = {{\sum }^{k = N}}_{K = o} {C}_{k} x ( t - k )$$

The coefficients Cₒ to Cₖ are given by

$${C}_{k} ( t + 1 ) = {C}_{k} ( t ) + [ 2 x \cdot e ( t ) \cdot x ( t - k ) ] / {{\sum }^{N}}_{i = o} {x}^{2} ( t - i ) ,$$

t=time-slot member within a sample;

x=a constant of step size within a sample, generally between 0.05 to 0.1; and

e=error (difference between actual and estimated energy in previous time-slot).

The number of samples (tₘₐₓ) within a block, assuming a block length of 256 m seconds and a sampling rate of 16 kHz (every 0.0625 m second) simply is

$$\frac{256}{0.0625} = 4 \text{,} 096 sample$$

Accordingly, N=4,096. The delay D in theory equals the block length, but due to processing time is longer by a few mseconds.

The scaling factor controlling the gain of the scaling amplifier 17 would conveniently be adjustable depending on the proximity of individual(s) in the region B to the loudspeaker(s) 18. However, the spectrum estimator 13 would simply cause the generation of filter parameters to match the interfering spectrum.

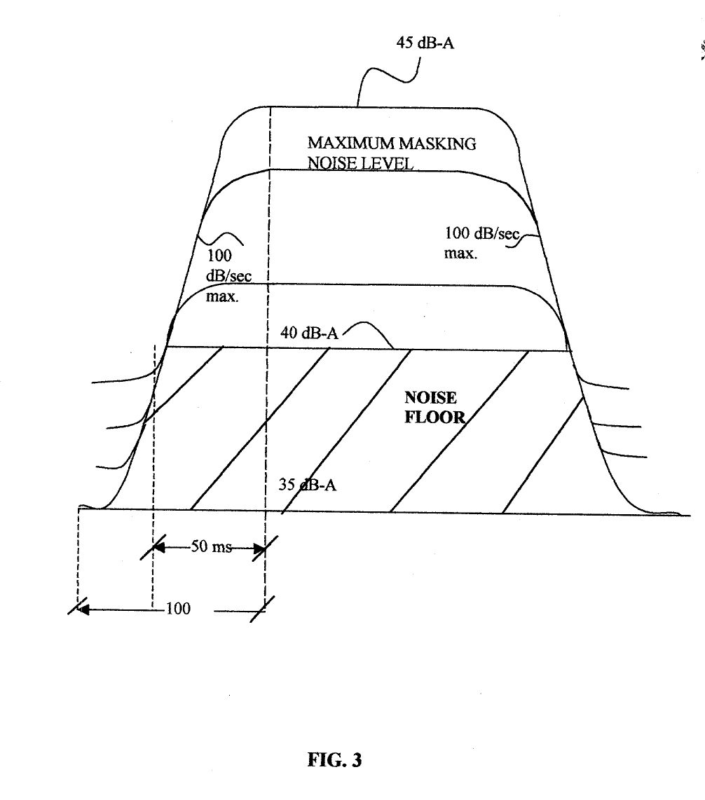

FIG. 3 shows the preferred system performance requirements, with a noise-floor between 35 dB-A (A-weighted) and 40 dB-A. Most systems in an office environment would not require a masking noise level higher than 45 dB-A, but this is at the designers' discretion.

What is claimed is:

1. A method for adaptive sound masking comprising the steps of:
(i) acquiring a signal representing undesired sound;
(ii) partitioning the acquired signal into time blocks;
(iii) estimating sound power level in the time blocks;
(iv) estimating frequency spectrum in the time blocks; and
(v) generating white noise with a shaped spectrum and at a power level matching levels estimated in steps (iii) and (iv).

2. A system for adaptive sound masking, comprising:
(i) means for acquiring a signal representing undesired sound;
(ii) means for partitioning the acquired signal into time blocks;
(iii) means for estimating sound power level in the time blocks;
(iv) means for estimating frequency spectrum in the time blocks; and
(v) means for generating white noise with a shaped spectrum and at a power level matching levels estimated in steps (iii) and (iv).
